(19) United States
(12) Patent Application Publication
(10) Pub. No.: US 2015/0069011 A1
(43) Pub. Date: Mar. 12, 2015

(54) WET ETCHING PATTERNING COMPOSITIONS AND METHODS

(71) Applicant: Carestream Health, Inc., Rochester, NY (US)

(72) Inventors: Liping Guo, Woodbury, MN (US); Erin R. Bell, Woodbury, MN (US); Chaofeng Zou, Maplewood, MN (US); Lawrence S. Dahedl, Stacy, MN (US)

(21) Appl. No.: 14/454,015

(22) Filed: Aug. 7, 2014

Related U.S. Application Data
(60) Provisional application No. 61/876,417, filed on Sep. 11, 2013.

(51) Int. Cl. C23F 1/30; G06F 3/044

(52) U.S. Cl. CPC C23F 1/30; G06F 3/044
USPC 216/13

(57) ABSTRACT

A method comprising etching a film comprising electrically conductive structures according to a pattern using an aqueous etching solution to provide an etched region having a first conductivity and an unetched region having a second conductivity, the second conductivity being greater than the first conductivity, wherein the aqueous etching solution either comprises 25 to 65% by weight of phosphoric acid and 1 to 18% by weight of nitric acid, or the aqueous etching solution comprises 65 to 75% by weight of nitric acid.

### CROSS REFERENCE TO RELATED APPLICATIONS

This application claims the benefit of U.S. Provisional Patent Application No. 61/876,417, filed Sep. 11, 2013, entitled “WET ETCHING PATTERNING COMPOSITIONS AND METHODS,” which is hereby incorporated by reference in its entirety.

### BACKGROUND

Electrically conductive films are used in electronic applications, such as touch screen sensors for portable electronic devices. Electrically conductive films comprising metal nanowires, such as, for example, silver nanowires, are particularly well suited for such applications because of their high conductivity, high optical transparency, and flexibility.

For many applications, such as, for example, capacitive touch screen devices, films are patterned to provide regions of different conductivities. The presence of a finger may be detected by circuitry attached to the patterned film. Non-conductive regions can be formed by chemically etching the film. See for example, Allemand et al., U.S. Pat. No. 8,174,667, and Winoto et al., U.S. Patent Publication 2011/0253668, which are hereby incorporated by reference in their entirety.

### SUMMARY

In some embodiments, a method may comprise etching a film comprising electrically conductive structures according to a pattern using an aqueous etching solution to provide an etched region having a first conductivity and an unetched region having a second conductivity, the second conductivity being greater than the first conductivity, where the aqueous etching solution may comprise 25 to 65% by weight of phosphoric acid and 1 to 18% by weight of nitric acid. Such a film may, in some cases, be electrically conductive prior to etching.

In some embodiments, the aqueous etching solution may comprise 40 to 60% by weight of phosphoric acid, 10 to 15% by weight of nitric acid, and 0.005-0.05% by weight surfactant. In some embodiments, the aqueous etching solution may comprise 45% by weight of phosphoric acid, 15% by weight of nitric acid, and 0.01% by weight surfactant. In some embodiments, the aqueous etching solution may comprise 50% by weight of phosphoric acid, 10% by weight of nitric acid, and 0.01% by weight surfactant. In some embodiments, the aqueous etching solution may comprise 63.5% by weight of phosphoric acid and 14.5% by weight of nitric acid. In some embodiments, the aqueous etching solution may comprise 40% by weight of phosphoric acid, 18% by weight of nitric acid, and 0.01% by weight surfactant. In some embodiments, the aqueous etching solution may comprise 60% by weight of phosphoric acid, 10% by weight of nitric acid, and 0.01% by weight surfactant. In some embodiments, the aqueous etching solution may comprise 6 to 12% by weight of hydrochloric acid, 25 to 35% by weight of phosphoric acid, and 0 to 1.5% by weight of nitric acid. In some embodiments, the aqueous etching solution may comprise 7% by weight of hydrochloric acid, 34% by weight of phosphoric acid, and 1% by weight of nitric acid. In some embodiments, the aqueous etching solution may comprise 10% by weight of hydrochloric acid, 26% by weight of phosphoric acid, and 1% by weight of nitric acid.

In some embodiments, prior to etching, the film may exhibit a preexisting set of optical properties, and after etching, the etched region may exhibit a first consequent set of optical properties, and the unetched region may exhibit a second consequent set of optical properties, and the preexisting set of optical properties and the first consequent set of optical properties may be substantially identical. In some embodiments, the preexisting set of optical properties may comprise a preexisting total light transmission and the first consequent set of optical properties may comprise a first consequent total light transmission that may be substantially identical to the preexisting total light transmission. In some embodiments, the preexisting set of optical properties may comprise a preexisting haze and the first consequent set of optical properties may comprise a first consequent haze that may be substantially identical to the preexisting haze. In some embodiments, the preexisting set of optical properties may comprise a preexisting L* value and the first consequent set of optical properties may comprise a first consequent L* value that may be substantially identical to the preexisting L* value. In some embodiments, the preexisting set of optical properties may comprise a preexisting a* value and the first consequent set of optical properties may comprise a first consequent a* value that may be substantially identical to the preexisting a* value. In some embodiments, the preexisting set of optical properties may comprise a preexisting b* value and the first consequent set of optical properties may comprise a first consequent b* value that may be substantially identical to the preexisting b* value.

In some embodiments, the first consequent set of optical properties and the second consequent set of optical properties may be substantially identical. In some embodiments, the first consequent set of optical properties may comprise a first consequent total light transmission and the second consequent set of optical properties may comprise a second consequent total light transmission that may be substantially identical to the first consequent total light transmission. In some embodiments, the first consequent set of optical properties may comprise a first consequent haze and the second consequent set of optical properties may comprise a second consequent haze that may be substantially identical to the first consequent haze. In some embodiments, the first consequent set of optical properties may comprise a first consequent L* value and the second consequent set of optical properties may comprise a second consequent L* value that may be substantially identical to the first consequent L* value. In some embodiments, the first consequent set of optical properties may comprise a first consequent a* value and the second consequent set of optical properties may comprise a second consequent a* value that may be substantially identical to the first consequent a* value. In some embodiments, the first consequent set of optical properties may comprise a first consequent b* value and the second consequent set of optical properties may comprise a second consequent b* value that may be substantially identical to the first consequent b* value.

In some embodiments, after etching, the pattern may be invisible to the unaided eye. In some embodiments, the absolute value of the difference between the preexisting haze and the first consequent haze may be less than about 0.1. In some embodiments, the absolute value of the difference between the first consequent haze and the second consequent haze may be less than about 0.1. In some embodiments, the absolute value of the difference between the preexisting b* value and the first consequent b* may be less than about 0.1. In some embodiments, the absolute value of the difference between the first consequent b* value and the second consequent b* value may be less than about 0.1. In some embodiments, the absolute value of the difference between the preexisting haze and the first consequent haze may be less than about 0.1, and the absolute value of the difference between the first consequent haze and the second consequent haze may be less than about 0.1. In some embodiments, the absolute value of the difference between the preexisting b* value and the first consequent b* may be less than about 0.1, and the absolute value of the difference between the first consequent b* value and the second consequent b* value may be less than about 0.1. In some embodiments, the electrically conductive structures may comprise silver nanowires.

In some embodiments, the aqueous etching solution comprises a surfactant, the aqueous etching solution comprising 42.5% by weight of phosphoric acid, 15% by weight of nitric acid, and 0.01% by weight of the surfactant. In some embodiments, the aqueous etching solution comprises a surfactant, the aqueous etching solution comprising 45% by weight of phosphoric acid, 13.75% by weight of nitric acid, and 0.01% by weight of the surfactant. In some embodiments, the aqueous etching solution comprises a surfactant, the aqueous etching solution comprising 45% by weight of phosphoric acid, 12.5% by weight of nitric acid, and 0.01% by weight of the surfactant. In some embodiments, the aqueous solution comprises a surfactant. In some embodiments, the aqueous solution comprises an anionic surfactant. In some embodiments, the aqueous solution comprises a surfactant, the surfactant comprising decyl(sulfophenoxy)benzenesulfonic acid, disodium salt, and oxybis(decylbenzenesulfonic acid). In some embodiments, prior to etching the film, a mask is disposed onto the film, and after etching the film, the mask is removed from the film by being dissolved in a solution. In some embodiments, prior to etching the film, a mask is disposed onto the film, and after etching the film, the mask is peeled from the film.

In some embodiments, a method may comprise etching a film comprising electrically conductive structures according to a pattern using an aqueous etching solution to provide an etched region having a first conductivity and an unetched region having a second conductivity, the second conductivity being greater than the first conductivity, where the aqueous etching solution may comprise 65 to 75% by weight of nitric acid. In some embodiments, the aqueous etching solution may comprise 70% by weight of nitric acid. Such a film may, in some cases, be electrically conductive prior to etching.

### DESCRIPTION

All publications, patents, and patent documents referred to in this document are herby incorporated by reference in their entirety, as though individually incorporated by reference.

U.S. Provisional Patent Application No. 61/876,417, filed Sep. 11, 2013, entitled “WET ETCHING PATTERNING COMPOSITIONS AND METHODS,” which hereby incorporated by reference in its entirety.

### INTRODUCTION

Applicants have discovered a method of patterning an electrically conductive film employing a composition comprising phosphoric acid and nitric acid. The composition may produce a patterned film having regions of suitably low conductivity while the pattern is invisible to the unaided eye with minimal top coat damage and without requiring additional processing steps, such as additional heating or quenching.

### Low and High Conductivity Regions of an Electrically Conductive Film

Electrically conductive films comprising electrically conductive structures, such as electrically conductive microstructures or electrically conductive nanostructures, are known. Microstructures and nanostructures are defined according to the length of their shortest dimensions. The shortest dimension of the nanostructure is sized between about 1 nm and about 100 nm. The shortest dimension of the microstructure is sized between about 0.1 μm and about 100 μm. Conductive nanostructures may include, for example, metal nanostructures. Non-limiting examples of electrically conductive nanostructures that may be incorporated into the electrically conductive layer include nanowires, nanotubes, metal meshes, graphenes, and oxides, such indium tin oxide. Such electrically conductive nanostructures may comprise metals, such as silver. For example, the electrically conductive nanostructures may be silver nanowires. Examples of transparent conductive films comprising silver nanowires and methods for preparing them are disclosed in US patent application publication 2012/0107600, entitled “TRANSPARENT CONDUCTIVE FILM COMPRISING CELLULOSE ESTERS,” which is hereby incorporated by reference in its entirety.

Such electrically conductive films may exhibit surface resistivities of about 100 ohms/sq or lower, such as, for example, 60 ohms/sq, prior to patterning. The electrically conductive films may be patterned to introduce low conductivity regions, leaving the remaining regions as high conductivity regions. In some embodiments, the low conductivity regions may have substantially no conductivity. In such cases, an Eddy Current meter may register a conductivity of 0. In some embodiments, the conductivity of the high conductivity regions after patterning may be within 10% (e.g. 5%, 1%) of the conductivity of the film prior to patterning.

Patterning methods are known in the art, such as chemical etching by screen printed mask, chemical etching by photolithography, chemical etching by screen printed etchant, or direct laser patterning. Such methods may include disposing a mask prior to etching a film, and the mask may be removed by being dissolved in a solution or peeling the mask from the film. In some cases, the fact that patterning has been performed may be obscured by making the high conductivity regions and low conductivity regions have similar optical properties, rendering the patterned film suitable for various end-use applications. Maintenance of the film's optical properties during the etching process can be important.

### Etchant Composition

Etchants may comprise one or more polar solvents, at least one acid, and optionally, at least one metal halide, at least one surfactant, or at least one polymer. In some embodiments, an acid etching solution may be used. An acidic etchant may comprise at least one acid. Non-limiting examples of acids include nitric acid, phosphoric acid, and hydrochloric acid. The acidic etchant may comprise an acid or a combination of acids with or without a binder. In some cases, the acidic etchant may etch the conductive nanostructures, such as silver nanowires, such that the silver nanowires are structurally compromised. In such cases, the etched silver nanowires may be no longer conductive or may become less conductive than the unetched silver nanowires.

In some embodiments, an aqueous etching solution may comprise 25 to 65% by weight of phosphoric acid and 1 to 18% by weight of nitric acid. In some embodiments, the aqueous etching solution may comprise 40 to 60% by weight of phosphoric acid, 10 to 15% by weight of nitric acid, and 0.005 to 0.05% by weight surfactant. In some embodiments, the aqueous etching solution may comprise 42.5% by weight of phosphoric acid, 15% by weight of nitric acid, and 0.01% by weight of a surfactant. In some embodiments, the aqueous etching solution may comprise 45% by weight of phosphoric acid, 13.75% by weight of nitric acid, and 0.01% by weight of a surfactant. In some embodiments, the aqueous etching solution may comprise 45% by weight of phosphoric acid, 12.5% by weight of nitric acid, and 0.01% by weight of a surfactant. In some embodiments, the aqueous etching solution may comprise 45% by weight of phosphoric acid, 15% by weight of nitric acid, and 0.01% by weight of a surfactant. In some embodiments, the aqueous etching solution may comprise 50% by weight of phosphoric acid, 10% by weight of nitric acid, and 0.01% by weight of a surfactant. In some embodiments, the aqueous etching solution may comprise 55% by weight of phosphoric acid and 15% by weight of nitric acid. In some embodiments, the aqueous etching solution may comprise 55% by volume of phosphoric acid, 15% by volume of nitric acid, and 20% by volume of water. In such cases, the aqueous etching solution may comprise about 63.5% by weight of phosphoric acid, 14.5% by weight of nitric acid, and 13.7% by weight of water. In some embodiments, the aqueous etching solution may comprise 40% by weight of phosphoric acid, 18% by weight of nitric acid, and 0.01% by weight surfactant. In some embodiments, the aqueous etching solution may comprise 60% by weight of phosphoric acid, 10% by weight of nitric acid, and 0.01% by weight surfactant. In some embodiments, the aqueous etching solution may comprise 6 to 12% by weight of hydrochloric acid, 25 to 35% by weight of phosphoric acid, and 0 to 1.5% by weight of nitric acid. In some embodiments, the aqueous etching solution may comprise 7% by weight of hydrochloric acid, 34% by weight of phosphoric acid, and 1% by weight of nitric acid. In some embodiments, the aqueous etching solution may comprise 10% by weight of hydrochloric acid, 26% by weight of phosphoric acid, and 1% by weight of nitric acid. In some embodiments, the surfactant may be an anionic surfactant, such as, for example, DOWFAX™ 3B2, available from The Dow Chemical Company.

### Optical Properties

In some embodiments, prior to etching the electrically conductive film, the film may exhibit a preexisting set of optical properties, and after etching the film in at least one region, the etched region may exhibit a first consequent set of optical properties that are substantially identical to the preexisting set of optical properties. In some embodiments, after etching the film in at least one region, an unetched region may exhibit a second consequent set of optical properties that are substantially identical to the first consequent set of optical properties. For the purpose of this application, the term “substantially identical” indicates differences that are not discernible to the unaided eye. In some embodiments, the absolute value of the differences between the preexisting set of optical properties and the first consequent set of optical properties or the first consequent set of optical properties and the second consequent set of optical properties may be less than 0.3 (e.g. less than 0.2, less than 0.1) for optical differences that remain indiscernible to the unaided eye. In such cases, the pattern may be invisible.

Such a preexisting set of optical properties may, for example, comprise one or more of a preexisting total light transmission, a preexisting haze, a preexisting L* value, a preexisting a* value, or a preexisting b* value. Such a first consequent set of optical properties may, for example, comprise one or more of a first consequent total light transmission, a first consequent haze, a first consequent L* value, a first consequent a* value, or a first consequent b* value. Such a second consequent set of optical properties may, for example, comprise one or more of a second consequent total light transmission, a second consequent haze, a second consequent L* value, a second consequent a* value, or a second consequent b* value. In some embodiments, the absolute value of the differences between the preexisting set b* value and the first consequent b* or the first consequent b* value and the second consequent b* value may be less than 0.3 (e.g. less than 0.2, less than 0.1) for optical differences that remain indiscernible or a pattern invisible to the unaided eye. In some embodiments, the absolute value of the differences between the preexisting haze and the first consequent haze or the first consequent haze and the second consequent haze may be less than 0.3 (e.g. less than 0.2, less than 0.1) for optical differences that remain indiscernible or a pattern invisible to the unaided eye. In some embodiments, a combination of the absolute value of the differences between the preexisting set b* value and the first consequent b* or the first consequent b* value and the second consequent b* value may be less than 0.3 (e.g. less than 0.2, less than 0.1) and the absolute value of the differences between the preexisting haze and the first consequent haze or the first consequent haze and the second consequent haze may be less than 0.3 (e.g. less than 0.2, less than 0.1) for optical differences that remain indiscernible or a pattern invisible to the unaided eye.

### EXEMPLARY EMBODIMENTS

U.S. Provisional Patent Application No. 61/876,417, filed Sep. 11, 2013, entitled “WET ETCHING PATTERNING COMPOSITIONS AND METHODS,” which is hereby incorporated by reference in its entirety, disclosed the following 40 non-limiting exemplary embodiments:

A. A method comprising:

etching a film comprising electrically conductive structures according to a pattern using an aqueous etching solution to provide an etched region having a first conductivity and an unetched region having a second conductivity, the second conductivity being greater than the first conductivity,

wherein the aqueous etching solution comprises 25 to 65% by weight of phosphoric acid and 1 to 18% by weight of nitric acid.

B. The method according to embodiment A, wherein the aqueous etching solution comprises a surfactant, the aqueous etching solution comprising 40 to 60% by weight of phosphoric acid, 10 to 15% by weight of nitric acid, and 0.005-0.05% by weight of the surfactant.
C. The method according to either of embodiments A or B, wherein the aqueous etching solution comprises a surfactant, the aqueous etching solution comprising 45% by weight of phosphoric acid, 15% by weight of nitric acid, and 0.01% by weight of the surfactant.
D. The method according to either of embodiments A or B, wherein the aqueous etching solution comprise a surfactant, the aqueous etching solution comprising 50% by weight of phosphoric acid, 10% by weight of nitric acid, and 0.01% by weight of the surfactant.
E. The method according to either of embodiments A or B, wherein the aqueous etching solution comprises 63.5% by weight of phosphoric acid and 14.5% by weight of nitric acid.
F. The method according to any of either of embodiments A or B, wherein the aqueous etching solution comprises a surfactant, the aqueous etching solution comprising 40% by weight of phosphoric acid, 18% by weight of nitric acid, and 0.01% by weight of the surfactant.
G. The method according to either of embodiments A or B, wherein the aqueous etching solution comprises a surfactant, the aqueous etching solution comprising 60% by weight of phosphoric acid, 10% by weight of nitric acid, and 0.01% by weight of the surfactant.
H. The method according to embodiment A, wherein the aqueous etching solution further comprises hydrochloric acid, the aqueous etching solution comprising 6 to 12% by weight of hydrochloric acid, 25 to 35% by weight of phosphoric acid, and 0 to 1.5% by weight of nitric acid.
J. The method according to either of embodiments A and H, wherein the aqueous etching solution further comprises hydrochloric acid, the aqueous etching solution comprising 7% by weight of hydrochloric acid, 34% by weight of phosphoric acid, and 1% by weight of nitric acid.
K. The method according to either of embodiments A and H, wherein the aqueous etching solution further comprises hydrochloric acid, the aqueous etching solution comprising 10% by weight of hydrochloric acid, 26% by weight of phosphoric acid, and 1% by weight of nitric acid.
L. The method according to any of embodiments A-K,

wherein prior to etching, the film exhibited a preexisting set of optical properties, and wherein after etching, the etched region exhibited a first consequent set of optical properties, and the unetched region exhibited a second consequent set of optical properties, and

further wherein the preexisting set of optical properties and the first consequent set of optical properties are substantially identical.

M. The method according to embodiment L, wherein the preexisting set of optical properties comprises a preexisting total light transmission and the first consequent set of optical properties comprises a first consequent total light transmission that is substantially identical to the preexisting total light transmission.
N. The method according to embodiment L, wherein the preexisting set of optical properties comprises a preexisting haze and the first consequent set of optical properties comprises a first consequent haze that is substantially identical to the preexisting haze.
P. The method according to embodiment L, wherein the preexisting set of optical properties comprises a preexisting L* value and the first consequent set of optical properties comprises a first consequent L* value that is substantially identical to the preexisting L* value.
Q. The method according to embodiment L, wherein the preexisting set of optical properties comprises a preexisting a* value and the first consequent set of optical properties comprises a first consequent a* value that is substantially identical to the preexisting a* value.
R. The method according to embodiment L, wherein the preexisting set of optical properties comprises a preexisting b* value and the first consequent set of optical properties comprises a first consequent b* value that is substantially identical to the preexisting b* value.
S. The method according to embodiment L, wherein the first consequent set of optical properties and the second consequent set of optical properties are substantially identical.
T. The method according to embodiment 17, wherein the first consequent set of optical properties comprises a first consequent total light transmission and the second consequent set of optical properties comprises a second consequent total light transmission that is substantially identical to the first consequent total light transmission.
U. The method according to embodiment 17, wherein the first consequent set of optical properties comprises a first consequent haze and the second consequent set of optical properties comprises a second consequent haze that is substantially identical to the first consequent haze.
V. The method according to embodiment 17, wherein the first consequent set of optical properties comprises a first consequent L* value and the second consequent set of optical properties comprises a second consequent L* value that is substantially identical to the first consequent L* value.
W. The method according to embodiment 17, wherein the first consequent set of optical properties comprises a first consequent a* value and the second consequent set of optical properties comprises a second consequent a* value that is substantially identical to the first consequent a* value.
X. The method according to embodiment 17, wherein the first consequent set of optical properties comprises a first consequent b* value and the second consequent set of optical properties comprises a second consequent b* value that is substantially identical to the first consequent b* value.
Y. The method according to any of embodiments A-X, wherein after etching, the pattern is invisible to the unaided eye.
Z. The method according to embodiment N, wherein the absolute value of the difference between the preexisting haze and the first consequent haze is less than about 0.1.
AA. The method according to embodiment U, wherein the absolute value of the difference between the first consequent haze and the second consequent haze is less than about 0.1.
AB. The method according to embodiment R, wherein the absolute value of the difference between the preexisting b* value and the first consequent b* is less than about 0.1.
AC. The method according to embodiment X, wherein the absolute value of the difference between the first consequent b* value and the second consequent b* value is less than about 0.1.
AD. The method according to either of embodiments N or U,

wherein the absolute value of the difference between the preexisting haze and the first consequent haze is less than about 0.1, and

wherein the absolute value of the difference between the first consequent haze and the second consequent haze is less than about 0.1.

AE. The method according to either of embodiments R or X,

wherein the absolute value of the difference between the preexisting b* value and the first consequent b* is less than about 0.1, and

wherein the absolute value of the difference between the first consequent b* value and the second consequent b* value is less than about 0.1.

AF. The method according to any of embodiments A-AE, wherein the electrically conductive structures comprise silver nanowires.
AG The method according to either of embodiments A or B, wherein the aqueous etching solution comprises a surfactant, the aqueous etching solution comprising 42.5% by weight of phosphoric acid, 15% by weight of nitric acid, and 0.01% by weight of the surfactant.
AH. The method according to either of embodiments A or B, wherein the aqueous etching solution comprises a surfactant, the aqueous etching solution comprising 45% by weight of phosphoric acid, 13.75% by weight of nitric acid, and 0.01% by weight of the surfactant.
AJ. The method according to either of embodiments A or B, wherein the aqueous etching solution comprises a surfactant, the aqueous etching solution comprising 45% by weight of phosphoric acid, 12.5% by weight of nitric acid, and 0.01% by weight of the surfactant.
AK. The method according to any of embodiments A-AJ, wherein the aqueous solution comprises a surfactant.
AL. The method according to any of embodiments A-AK, wherein the aqueous solution comprises an anionic surfactant.
AM. The method according to any of embodiments A-AL, wherein the aqueous solution comprises a surfactant, the surfactant comprising decyl(sulfophenoxy)benzenesulfonic acid, disodium salt, and oxybis(decylbenzenesulfonic acid).
AN. The method according to any of embodiments A-AM, wherein prior to etching the film, a mask is disposed onto the film, and wherein after etching the film, the mask is removed from the film by being dissolved in a solution.
AP. The method according to any of embodiments A-AN, wherein prior to etching the film, a mask is disposed onto the film, and wherein after etching the film, the mask is peeled from the film.
AQ. A method comprising:

etching a film comprising electrically conductive structures according to a pattern using an aqueous etching solution to provide an etched region having a first conductivity and an unetched region having a second conductivity, the second conductivity being greater than the first conductivity,

wherein the aqueous etching solution comprises 65 to 75% by weight of nitric acid.

AR. The method according to embodiment AQ, wherein the aqueous etching solution comprises 70% by weight of nitric acid.

### EXAMPLES

### Methods

Electrical conductivity of films was measured using a 707 Conductance Monitor (Delcom Instruments Inc.).

Percent transmittance and percent haze of films were measured according to the ASTM D-1003 test method using a BYK-Gardner HAZE-GARD PLUS hazemeter.

CIE L*, a*, and b* color metrics of films were measured using a HunterLab ULTRASCAN® VIS colorimeter.

Screen printing was performed using a Model F1-12 precision screen printer (Systematic Automation, Farmington, Conn.) equipped with a 305 mesh screen, which is a rectangular or a square block of material.

### Materials

All materials (e.g. phosphoric acid, nitric acid, hydrochloric acid, etc.) used in the following examples are readily available from standard commercial sources, such as Sigma-Aldrich Co. LLC. (St. Louis, Mo.) unless otherwise specified.

DOWFAX™ 3B2 anionic surfactant is an aqueous solution comprising less than or equal to 38% decyl(sulfophenoxy)benzenesulfonic acid, disodium salt, and less than or equal to 8% oxybis(decylbenzenesulfonic acid), disodium salt (Dow Chemical).

FLEXX™ 100 is a transparent conductive film comprising silver nanowires (Carestream Health, Inc., Rochester, N.Y.).

GC-UV-60 ink is a screen printable UV curable resist (Green Cure Technology Corporation, Ltd., Taiwan).
LP400-BL8 ink is a screen printable UV curable resist (Green Cure Technology Corporation, Ltd., Taiwan).
HOYO MI-B077 is a screen printable and thermal curable mask available from Hoyo-Chemical. It is reported to be a peelable mask that does not require a stripping agent.

### Analysis

Samples of film having etched regions with 0 conductivity readings were selected for further calculations of changes in percent haze and CIE L*, a*, b* and visual observation of invisibility of the pattern. Films visually observed to be invisible tended to have changes in percent haze and CIE L*, a*, and b* of less than 0.1.

### Example 1

Samples of FLEXX™ 100 transparent conductive film (Lot 244-3133, Carestream Health, Inc., Rochester, N.Y.), which had a resistivity of 100 Ohms, were annealed at 150° C. for 30 minutes. Initial measurements of electrical conductivity and percent haze were recorded. Masks were disposed onto the samples by being screen printed with a GC-UV-60A ink and cured with a UV lamp at about 230 mJ/cm² with one pass at a rate of 30 ft/m. The samples were dipped into a various etchant compositions (varying wt % of H₃PO₄, HNO₃, HCl, or H₂O) at a selected temperatures (room temperature of about 21° C., 40° C., or 45° C.) for selected times (60, 120, or 180 seconds). To remove excess etchant, the samples were washed with distilled water. The masks were removed by dipping the sample into a 35° C. 3% (w/v) aqueous solution of sodium hydroxide for 71 seconds. The samples were washed with distilled water and oven dried at 230° F. for 2 to 3 minutes. Final measurements of electrical conductivity and percent haze were recorded. Table 1 shows the electrical conductivity and haze of the etched region after stripping. (RT indicates “room temperature,” while NC denotes “not checked.”

TABLE 1

| | Etchant | | | | | |
|---|---|---|---|---|---|---|
| | Composition | | | | | |
| | (wt %) | | | | | |
| | H₃PO₄/ | Etchant | Etching | Eddy Current | | |
| | HNO₃/HCl/ | Temp | Time | (mmhos) | | Delta |
| Sample | H₂O | (° C.) | (s) | initial | etched | Haze |
| 1-1 | 0/1/21/78 | RT | 60 | 8 11.02 | 6.56 | −0.06 |
| 1-2 | 0/1/21/79 | RT | 60 | 11.73 | 6.98 | −0.11 |
| 1-3 | 0/1/21/80 | RT | 120 | 12.53 | 0.52 | −0.18 |
| 1-4 | 0/1/21/81 | RT | 120 | 11.6 | 0.61 | −0.2 |
| 1-5 | 0/1/21/82 | RT | 180 | 12.18 | 0 | −0.3 |
| 1-6 | 0/1/21/83 | RT | 180 | 12.08 | 0 | −0.31 |
| 1-7 | 34/1/7/58 | RT | 60 | 12.85 | 11.1 | NC |
| 1-8 | 34/1/7/59 | RT | 60 | 12.47 | 12.33 | NC |
| 1-9 | 34/1/7/60 | RT | 120 | 10.65 | 10.59 | NC |
| 1-10 | 34/1/7/61 | RT | 120 | 11.26 | 10.54 | NC |
| 1-11 | 34/1/7/62 | RT | 180 | 10.83 | 9.14 | NC |
| 1-12 | 34/1/7/63 | RT | 180 | 11.95 | 12.14 | NC |
| 1-13 | 26/1/10/63 | RT | 60 | 12.9 | 8.92 | NC |
| 1-14 | 26/1/10/64 | RT | 60 | 12.4 | 11 | NC |
| 1-15 | 26/1/10/65 | RT | 120 | 11.31 | 10.59 | NC |
| 1-16 | 26/1/10/66 | RT | 120 | 11.43 | 10.71 | NC |
| 1-17 | 26/1/10/67 | RT | 180 | 9.67 | 9.98 | NC |
| 1-18 | 26/1/10/68 | RT | 180 | 9.01 | 8.54 | NC |
| 1-19 | 0/1/21/78 | 40 | 60 | 11.4 | 0 | −0.51 |
| 1-20 | 0/1/21/79 | 40 | 60 | 11.37 | 0 | −0.51 |
| 1-21 | 0/1/21/80 | 40 | 120 | 12.11 | 0 | −0.52 |
| 1-22 | 0/1/21/81 | 40 | 120 | 11.04 | 0 | −0.61 |
| 1-23 | 0/1/21/82 | 40 | 180 | 11.28 | 0 | −0.57 |
| 1-24 | 0/1/21/83 | 40 | 180 | 11.91 | 0 | −0.54 |
| 1-25 | 34/1/7/58 | 40 | 60 | 12.11 | 11.22 | NC |
| 1-26 | 34/1/7/59 | 40 | 60 | 10.66 | 11.4 | NC |
| 1-27 | 34/1/7/60 | 40 | 120 | 12.06 | 2.94 | −0.11 |
| 1-28 | 34/1/7/61 | 40 | 120 | 12.26 | 2.68 | −0.17 |
| 1-29 | 34/1/7/62 | 40 | 180 | 12.38 | 0 | 0.01 |
| 1-30 | 34/1/7/63 | 40 | 180 | 11.72 | 0 | −0.12 |
| 1-31 | 26/1/10/63 | 40 | 60 | 12.31 | 6.13 | −0.06 |
| 1-32 | 26/1/10/64 | 40 | 60 | 10.53 | 6.27 | −0.02 |
| 1-33 | 26/1/10/65 | 40 | 120 | 11.29 | 0 | 0.06 |
| 1-34 | 26/1/10/66 | 40 | 120 | 12.03 | 0 | −0.21 |
| 1-35 | 26/1/10/67 | 40 | 180 | 11.8 | 0 | −0.24 |
| 1-36 | 26/1/10/68 | 40 | 180 | 11.92 | 0 | −0.29 |
| 1-37 | 34/1/7/58 | 45 | 60 | 11.56 | 2.43 | −0.1 |
| 1-38 | 34/1/7/59 | 45 | 60 | 12.55 | 3.76 | −0.27 |
| 1-39 | 34/1/7/60 | 45 | 120 | 10.7 | 0 | −0.28 |
| 1-40 | 34/1/7/61 | 45 | 120 | 11.61 | 0 | −0.33 |
| 1-41 | 34/1/7/62 | 45 | 180 | 11.68 | 0 | −0.33 |
| 1-42 | 34/1/7/63 | 45 | 180 | 11.82 | 0 | −0.49 |

### Example 2

Samples of FLEXX™ 100 transparent conductive film (Lot 308-3112, Carestream Health, Inc., Rochester, N.Y.), which had a resistivity of 100 Ohms, were annealed at 150° C. for 30 minutes. Initial measurements of electrical conductivity, percent transmittance, percent haze, and CIE L*, a*, and b* color metrics were recorded. Masks were disposed onto the samples by being screen printed with an LP400-BL8 ink and cured at with a UV lamp at about 230 mJ/cm² with one pass at a rate of 20 ft/m. The masked samples were dipped into various etchant compositions (varying wt % of H₃PO₄, HNO₃, HCl, or H₂O) at selected temperatures (room temperature of about 21° C. or 35° C.) for selected times (30, 60, 120, or 180 seconds). To remove excess etchant, the samples were washed with distilled water and dried with compressed air using a blower. Final measurements of conductivity, percent transmittance, percent haze, and CIE L*, a*, and b* color metrics were recorded for the etched areas. Table 2 shows the electrical conductivity, change in percent haze, and change in b* of the etched region after etching. (RT indicates “room temperature.”)

TABLE 2

| | Etchant | | | | | | |
|---|---|---|---|---|---|---|---|
| | Composition | | | | | | |
| | (wt %) | | | | | | |
| | H₃PO₄/ | Etchant | Etching | Eddy Current | | | |
| | HNO₃/ | Temp | Time | (mmhos) | | Delta | Delta |
| Sample | HCl/H₂O | (° C.) | (s) | initial | etched | Haze | b* |
| 2-1 | 0/18/0/0.01 | RT | 30 | 11.78 | 11.9 | −0.01 | −0.08 |
| 2-2 | 0/18/0/0.01 | RT | 60 | 12.09 | 12.2 | 0 | −0.04 |
| 2-3 | 0/18/0/0.01 | RT | 90 | 12.18 | 12.2 | 0.19 | −0.06 |
| 2-4 | 0/18/0/0.01 | RT | 120 | 9.73 | 9.92 | −0.02 | −0.07 |
| 2-5 | 40/18/0/0.01 | RT | 30 | 9.64 | 10.1 | −0.02 | −0.26 |
| 2-6 | 40/18/0/0.01 | RT | 60 | 10.21 | 9.64 | −0.07 | −0.16 |
| 2-7 | 40/18/0/0.01 | RT | 90 | 12.12 | 2.16 | −0.01 | −0.07 |
| 2-8 | 40/18/0/0.01 | RT | 120 | 11.87 | 0.25 | −0.01 | −0.02 |
| 2-9 | 0/0/15/0.01 | RT | 30 | 11.69 | 11.8 | 0.06 | −0.06 |
| 2-10 | 0/0/15/0.01 | RT | 60 | 11.66 | 12.1 | −0.05 | 0.11 |
| 2-11 | 0/0/15/0.01 | RT | 90 | 11.7 | 12 | 0.02 | −0.14 |
| 2-12 | 0/0/15/0.01 | RT | 120 | 11.3 | 11.5 | −0.01 | 0.02 |
| 2-13 | 40/0/15/0.01 | RT | 30 | 11.68 | 12.7 | −0.01 | −0.06 |
| 2-14 | 40/0/15/0.01 | RT | 60 | 11.82 | 12.6 | −0.13 | −0.16 |
| 2-15 | 40/0/15/0.01 | RT | 90 | 11.73 | 12.9 | −0.04 | −0.17 |
| 2-16 | 40/0/15/0.01 | RT | 120 | 12.2 | 13.7 | 0.03 | −0.19 |
| 2-17 | 70/0/0/0.01 | RT | 30 | 10.11 | 10.28 | 0.08 | −0.04 |
| 2-18 | 70/0/0/0.01 | RT | 60 | 10.14 | 10.75 | 0.06 | −0.03 |
| 2-19 | 70/0/0/0.01 | RT | 90 | 10.21 | 10.69 | 0.09 | 0 |
| 2-20 | 70/0/0/0.01 | RT | 120 | 11.61 | 12.27 | 0.04 | −0.05 |
| 2-21 | 0/70/0/0.01 | RT | 30 | 11.7 | 0 | −0.19 | 0.11 |
| 2-22 | 0/70/0/0.01 | RT | 60 | 11.34 | 0 | −0.31 | −0.34 |
| 2-23 | 0/70/0/0.01 | RT | 90 | 10.43 | 0 | 0.01 | −0.45 |
| 2-24 | 0/70/0/0.01 | RT | 120 | 10.41 | 0 | 0.5 | −0.68 |
| 2-25 | 0/0/37/0.01 | RT | 30 | 10.23 | 11.49 | 0.14 | −0.46 |
| 2-26 | 0/0/37/0.01 | RT | 60 | 10.01 | 11.49 | 0.26 | −0.34 |
| 2-27 | 0/0/37/0.01 | RT | 90 | 10.04 | 11.46 | 0.05 | −0.28 |
| 2-28 | 0/0/37/0.01 | RT | 120 | 10.01 | 11.44 | 0.23 | −0.11 |
| 2-29 | 0/18/0/0.01 | 35 | 30 | 11.92 | 12.1 | −0.01 | −0.17 |
| 2-30 | 0/18/0/0.01 | 35 | 60 | 11.65 | 11.8 | −0.03 | −0.17 |
| 2-31 | 0/18/0/0.01 | 35 | 90 | 12.5 | 12.9 | 0.01 | −0.07 |
| 2-32 | 0/18/0/0.01 | 35 | 120 | 12.23 | 12.1 | 0.03 | −0.1 |
| 2-33 | 40/18/0/0.01 | 35 | 30 | 11.9 | 0 | −0.03 | 0 |
| 2-34 | 40/18/0/0.01 | 35 | 60 | 10.07 | 0 | −0.08 | −0.19 |
| 2-35 | 40/18/0/0.01 | 35 | 90 | 10.13 | 0 | −0.01 | −0.16 |
| 2-36 | 40/18/0/0.01 | 35 | 120 | 10.24 | 0 | −0.05 | −0.21 |
| 2-37 | 0/0/15/0.01 | 35 | 30 | 9.86 | 10 | 0.05 | −0.1 |
| 2-38 | 0/0/15/0.01 | 35 | 60 | 10.24 | 10.7 | −0.04 | −0.2 |
| 2-39 | 0/0/15/0.01 | 35 | 90 | 10.39 | 10.9 | 0 | −0.21 |
| 2-40 | 0/0/15/0.01 | 35 | 120 | 10.04 | 10.9 | −0.03 | −0.13 |
| 2-41 | 40/0/15/0.01 | 35 | 30 | 10.76 | 11.6 | 0.03 | −0.07 |
| 2-42 | 40/0/15/0.01 | 35 | 60 | 10.59 | 11.8 | 0.01 | −0.26 |
| 2-43 | 40/0/15/0.01 | 35 | 90 | 11.72 | 13.4 | 0.06 | −0.18 |
| 2-44 | 40/0/15/0.01 | 35 | 120 | 11.35 | 12.7 | 0.07 | −0.12 |

### Example 3

Samples of FLEXX™ 100 transparent conductive film (Lot 308-3112, Carestream Health, Inc., Rochester, N.Y.), which had a resistivity of 100 Ohms, were annealed at 150° C. for 30 minutes. Initial measurements of electrical conductivity, percent transmittance, percent haze, and CIE L*, a*, and b* color metrics were recorded. Masks were screen printed onto the samples and cured with a UV lamp at 230 mJ/cm² with one pass at a rate of 20 ft/m. The masked samples were dipped into a selected etchant composition (varying wt % of H₃PO₄, HClHNO₃, or 3B2, or H₂O) at selected temperatures (room temperature of about 21° C., 35° C., or 40° C.) for selected times (30, 60, 90, or 120 seconds). To remove excess etchant, the samples were washed with distilled water and dried with compressed air using a blower. The masks were removed by dipping the samples into an aqueous solution of 5% (w/v) sodium hydroxide. The samples were washed with distilled water and air dried. Final measurements of conductivity, percent transmittance, percent haze, and CIE L*, a*, and b* color metrics were recorded for the etched and masked areas. Tables 3A and 3B show the electrical conductivity, change in percent haze, and change in b* of the etched regions after the mask were removed and of the masked regions after etching. (RT indicates “room temperature.”)

TABLE 3A

| | | | | Electrical | | | | | |
|---|---|---|---|---|---|---|---|---|---|
| | Etchant Composition | Etchant | | Conductivity | | Delta | Delta | Delta | Delta |
| | (wt %) | Temp | Etching | (mmhos) | | Haze | b* | Haze | b* |
| Sample | H₃PO₄/HNO₃/HCl/H₂O | (° C.) | Time (s) | initial | etched | etched | etched | masked | masked |
| 3-1 | 40/15/0/0.01 | RT | 30 | 9.14 | 9.09 | 0.34 | −0.08 | 0.13 | −0.11 |
| 3-2 | 40/15/0/0.01 | RT | 60 | 9.04 | 8.61 | 0.47 | −0.06 | 0.12 | 0.05 |
| 3-3 | 40/15/0/0.01 | RT | 90 | 9.8 | 9.14 | 0.41 | −0.14 | 0.14 | −0.05 |
| 3-4 | 40/15/0/0.01 | RT | 120 | 10.27 | 8.33 | 0.42 | −0.11 | 0.2 | −0.23 |
| 3-5 | 40/10/0/0.01 | RT | 30 | 9.42 | 9.3 | 0.73 | −0.14 | 0.47 | −0.14 |
| 3-6 | 40/10/0/0.01 | RT | 60 | 8.69 | 8.37 | 0.19 | −0.11 | 0.06 | 0.16 |
| 3-7 | 40/10/0/0.01 | RT | 90 | 8.12 | 7.91 | 0.2 | −0.15 | 0.06 | −0.35 |
| 3-8 | 40/10/0/0.01 | RT | 120 | 7.98 | 7.88 | 0.23 | −0.06 | 0.05 | −0.32 |
| 3-9 | 60/18/0/0.01 | RT | 30 | 8.34 | 0 | 0.21 | 0.17 | 0.17 | −0.05 |
| 3-10 | 60/18/0/0.01 | RT | 60 | 11.22 | 0 | 0.75 | 0.33 | 0.32 | −0.08 |
| 3-11 | 60/18/0/0.01 | RT | 90 | 11.16 | 0 | 0.07 | −0.01 | −0.01 | 0.13 |
| 3-12 | 60/18/0/0.01 | RT | 120 | 11.45 | 0 | −0.38 | −0.18 | −0.13 | 0.34 |
| 3-13 | 60/15/0/0.01 | RT | 30 | 10.07 | 0.7 | 0.25 | 0.37 | 0.31 | −0.1 |
| 3-14 | 60/15/0/0.01 | RT | 60 | 9.8 | 0 | 0.37 | 0.3 | 0.16 | −0.26 |
| 3-15 | 60/15/0/0.01 | RT | 90 | 10.16 | 0 | −0.08 | 0.31 | 0.17 | −0.14 |
| 3-16 | 60/15/0/0.01 | RT | 120 | 10.87 | 0 | −0.3 | 0.21 | 0.27 | −0.07 |
| 3-17 | 60/10/0/0.01 | RT | 30 | 10.95 | 0 | 0.14 | 0.06 | 0.18 | −0.07 |
| 3-18 | 60/10/0/0.01 | RT | 60 | 11.42 | 0 | 0.19 | 0.11 | 0.22 | −0.07 |
| 3-19 | 60/10/0/0.01 | RT | 90 | 10.8 | 0 | 0.11 | 0.1 | 0.02 | −0.12 |
| 3-20 | 60/10/0/0.01 | RT | 120 | 10.54 | 0 | −0.02 | 0.21 | −0.01 | −0.09 |
| 3-21 | 40/15/0/0.01 | 40 | 30 | 10.55 | 0 | 0.29 | −0.08 | 0 | 0.12 |
| 3-22 | 40/15/0/0.01 | 40 | 60 | 9.66 | 0.24 | 0.15 | −0.07 | 0 | −0.02 |
| 3-23 | 40/15/0/0.01 | 40 | 90 | 9.39 | 0 | 0.06 | −0.05 | 0.07 | −0.09 |
| 3-24 | 40/15/0/0.01 | 40 | 120 | 10.11 | 0 | 0.34 | −0.01 | 0.12 | 0.02 |
| 3-25 | 40/10/0/0.01 | 40 | 30 | 10.74 | 10.39 | 0.23 | −0.14 | 0.06 | −0.16 |
| 3-26 | 40/10/0/0.01 | 40 | 60 | 9.76 | 9.6 | 0.1 | −0.17 | 0.08 | −0.1 |
| 3-27 | 40/10/0/0.01 | 40 | 90 | 9.55 | 9.06 | 0.18 | −0.11 | 0.34 | 0 |
| 3-28 | 40/10/0/0.01 | 40 | 120 | 9.34 | 8.62 | 0.45 | −0.16 | 0.08 | −0.13 |
| 3-29 | 60/18/0/0.01 | 40 | 30 | 9.08 | 0 | −0.69 | −0.29 | −0.1 | −0.08 |
| 3-30 | 60/18/0/0.01 | 40 | 60 | 9.24 | 0 | −0.56 | −0.63 | −0.57 | −0.31 |
| 3-31 | 60/18/0/0.01 | 40 | 90 | 8.26 | 0 | −0.67 | −0.64 | −0.72 | −0.6 |
| 3-32 | 60/18/0/0.01 | 40 | 120 | 8.31 | 0 | −0.72 | −0.51 | −0.78 | −0.72 |
| 3-33 | 60/15/0/0.01 | 40 | 30 | 10.12 | 0 | 0 | 0.58 | 0.42 | −0.27 |
| 3-34 | 60/15/0/0.01 | 40 | 60 | 10.02 | 0 | 0 | −0.12 | −0.57 | −0.67 |
| 3-35 | 60/15/0/0.01 | 40 | 90 | 10.242 | 0 | 0 | 0.2 | −0.85 | −0.82 |
| 3-36 | 60/15/0/0.01 | 40 | 120 | 11.07 | 0 | 0 | −0.05 | −0.78 | −0.81 |
| 3-37 | 60/10/0/0.01 | 40 | 30 | 8.36 | 0 | −0.19 | 0.15 | −0.11 | −0.26 |
| 3-38 | 60/10/0/0.01 | 40 | 60 | 10.26 | 0 | −0.23 | 0.06 | −0.07 | −0.06 |
| 3-39 | 60/10/0/0.01 | 40 | 90 | 9.87 | 0 | −0.39 | 0 | −0.01 | 0.05 |
| 3-40 | 60/10/0/0.01 | 40 | 120 | 9.74 | 0 | −0.49 | −0.18 | −0.14 | 0.04 |

TABLE 3B

| | | | | Electrical | | | | | |
|---|---|---|---|---|---|---|---|---|---|
| | Etchant Composition | Etchant | | Conductivity | | Delta | Delta | Delta | |
| | (wt %) | Temp | Etching | (mmhos) | | Haze | b* | Haze | Delta b* |
| Sample | H₃PO₄/HNO₃/3B2/H₂O | (° C.) | Time (s) | initial | etched | etched | etched | masked | masked |
| 3-41 | 40/15/0.01/44.99 | 35 | 30 | 10.31 | 9.86 | −0.06 | −0.07 | 0.93 | 0.14 |
| 3-42 | 40/15/0.01/44.99 | 35 | 60 | 11.07 | 9.62 | −0.01 | −0.07 | 0.23 | −0.06 |
| 3-43 | 40/15/0.01/44.99 | 35 | 90 | 9.83 | 0.71 | 0.12 | 0.02 | 1.58 | −0.19 |
| 3-44 | 40/15/0.01/44.99 | 35 | 120 | 10.25 | 1.29 | 0.03 | 0 | 0.26 | −0.16 |
| 3-45 | 45/15/0.01/39.99 | 35 | 30 | 10.42 | 0 | −0.13 | −0.03 | −0.09 | −0.12 |
| 3-46 | 45/15/0.01/39.99 | 35 | 60 | 10.9 | 0 | 0.36 | −0.07 | 0.21 | −0.05 |
| 3-47 | 45/15/0.01/39.99 | 35 | 90 | 9.1 | 0 | 0.14 | −0.1 | −0.05 | 0.05 |
| 3-48 | 45/15/0.01/39.99 | 35 | 120 | 8.95 | 0 | 0.05 | −0.14 | 0.08 | −0.25 |
| 3-49 | 50/15/0.01/34.99 | 35 | 30 | 9.1 | 0 | −0.06 | −0.05 | 0.11 | 0.11 |
| 3-50 | 50/15/0.01/34.99 | 35 | 60 | 8.81 | 0 | −0.01 | −0.13 | 0.18 | 0.01 |
| 3-51 | 50/15/0.01/34.99 | 35 | 90 | 9.34 | 0 | 0.01 | 0.03 | 0.36 | 0.26 |
| 3-52 | 50/15/0.01/34.99 | 35 | 120 | 8.43 | 0 | 0.01 | −0.2 | 0.2 | 0.06 |
| 3-53 | 45/10/0.01/44.99 | 35 | 30 | 10.05 | 9.88 | 0.01 | −0.11 | 0.31 | −0.13 |
| 3-54 | 45/10/0.01/44.99 | 35 | 60 | 10.41 | 10.04 | −0.01 | −0.14 | 1.56 | −0.131 |
| 3-55 | 45/10/0.01/44.99 | 35 | 90 | 10.49 | 10.05 | 0.02 | −0.07 | −0.04 | 0.01 |
| 3-56 | 45/10/0.01/44.99 | 35 | 120 | 10.25 | 9.88 | 0.01 | −0.11 | 0.1 | −0.08 |
| 3-57 | 50/10/0.01/39.99 | 35 | 30 | 10.09 | 9.94 | 0.13 | −0.13 | 0.25 | −0.1 |
| 3-58 | 50/10/0.01/39.99 | 35 | 60 | 10.25 | 8.47 | −0.01 | −0.11 | 0.29 | −0.09 |
| 3-59 | 50/10/0.01/39.99 | 35 | 90 | 11.81 | 1.3 | −0.03 | 0 | 0.13 | 0.12 |
| 3-60 | 50/10/0.01/39.99 | 35 | 120 | 9.19 | 0 | 0.1 | −0.14 | 0.18 | −0.14 |
| 3-61 | 55/10/0.01/34.99 | 35 | 30 | 10.93 | 0 | 0.08 | 0.09 | 0.05 | −0.25 |
| 3-62 | 55/10/0.01/34.99 | 35 | 60 | 9.84 | 0 | −0.04 | 0.13 | 0.06 | −0.37 |
| 3-63 | 55/10/0.01/34.99 | 35 | 90 | 11.14 | 0 | −0.16 | 0.14 | 0.65 | −0.04 |
| 3-64 | 55/10/0.01/34.99 | 35 | 120 | 9.38 | 0 | −0.33 | 0.06 | −0.04 | −0.27 |
| 3-65 | 40/15/0.01/44.99 | 40 | 30 | 10.11 | 9.16 | 0.12 | −0.15 | 0.56 | −0.14 |
| 3-66 | 40/15/0.01/44.99 | 40 | 60 | 9.85 | 0.81 | 0.63 | −0.12 | 0.67 | −0.14 |
| 3-67 | 40/15/0.01/44.99 | 40 | 90 | 10.74 | 0 | 0.37 | −0.19 | 0.19 | −0.14 |
| 3-68 | 40/15/0.01/44.99 | 40 | 120 | 10.29 | 0 | 0.03 | −0.07 | 0.32 | −0.07 |
| 3-69 | 45/15/0.01/39.99 | 40 | 30 | 10.42 | 0 | 0.3 | 0.03 | 0.04 | −0.25 |
| 3-70 | 45/15/0.01/39.99 | 40 | 60 | 10.17 | 0 | 0.48 | −0.06 | 1.22 | −0.16 |
| 3-71 | 45/15/0.01/39.99 | 40 | 90 | 8.57 | 0 | −0.01 | −0.03 | 0.23 | −0.35 |
| 3-72 | 45/15/0.01/39.99 | 40 | 120 | 10.06 | 0 | 0.01 | −0.11 | 0.28 | −0.18 |
| 3-73 | 50/15/0.01/34.99 | 40 | 30 | 9.21 | 0 | −0.21 | 0.13 | 0.94 | −0.37 |
| 3-74 | 50/15/0.01/34.99 | 40 | 60 | 10.61 | 0 | −0.55 | 0.11 | 0.46 | −0.32 |
| 3-75 | 50/15/0.01/34.99 | 40 | 90 | 9.25 | 0 | −0.68 | −0.02 | −0.08 | −0.34 |
| 3-76 | 50/15/0.01/34.99 | 40 | 120 | 10.51 | 0 | −0.66 | −0.58 | −0.05 | 0.4 |
| 3-77 | 45/10/0.01/44.99 | 40 | 30 | 10.07 | 9.44 | 0.19 | −0.16 | 0.08 | −0.13 |
| 3-78 | 45/10/0.01/44.99 | 40 | 60 | 9.27 | 8.93 | 0.02 | −0.11 | 0.11 | −0.24 |
| 3-79 | 45/10/0.01/44.99 | 40 | 90 | 10.01 | 9.39 | 0.08 | −0.15 | 0.91 | 0.04 |
| 3-80 | 45/10/0.01/44.99 | 40 | 120 | 9.61 | 9.11 | 0.04 | −0.15 | 0.07 | −0.17 |
| 3-81 | 50/10/0.01/39.99 | 40 | 30 | 9.94 | 8.63 | 0.01 | −0.17 | −0.11 | 0 |
| 3-82 | 50/10/0.01/39.99 | 40 | 60 | 9.97 | 1.07 | 0.04 | −0.1 | 0.02 | −0.12 |
| 3-83 | 50/10/0.01/39.99 | 40 | 90 | 9.41 | 0 | 0.01 | −0.06 | 0.11 | −0.18 |
| 3-84 | 50/10/0.01/39.99 | 40 | 120 | 8.3 | 0 | 0.02 | −0.06 | 0.19 | −0.3 |
| 3-85 | 55/10/0.01/34.99 | 40 | 30 | 8.49 | 0 | 0.5 | 0.1 | 0.27 | −0.38 |
| 3-86 | 55/10/0.01/34.99 | 40 | 60 | 9.35 | 0 | −0.06 | 0 | 0.32 | −0.3 |
| 3-87 | 55/10/0.01/34.99 | 40 | 90 | 8.51 | 0 | −0.03 | −0.01 | −0.15 | −0.23 |
| 3-88 | 55/10/0.01/34.99 | 40 | 120 | 9.36 | 0 | −0.03 | 0.07 | 0.03 | −0.34 |

### Example 4

Several samples of FLEXX™ 100 transparent conductive film (Lots 304-3114, 308-3111, 308-3112, 322-3120, 318-3127, 313-3120, 326-3107, 304-3114, Carestream Health, Inc., Rochester, N.Y.) were subjected to a similar process as described in Example 3, except that additional measurements of conductivity, percent transmittance, percent haze, and CIE L*, a*, and b* color metrics were recorded for the etched region prior to stripping the mask from the film and visual observations of invisibility of the stripped film were recorded. Table 4 shows the electrical conductivity, change in percent haze, change in b* of the etched region before and after the mask was removed and of the masked region after etching. (EC denotes “electrical conductivity” in mmhos.)

TABLE 4

| | | | | | | | | | | | | ΔHaze |
|---|---|---|---|---|---|---|---|---|---|---|---|---|
| | | | | | | | | | | | | etched |
| | | | | | | | | | | | | (After |
| | Etchant Composition | Etching | | Before Strip | | | | After Strip | | | | Strip − |
| | (wt %) | Temp | Etching | Initial | EC | | | ΔHaze | Δb* | ΔHaze | Δb* | Before |
| Sample | H₃PO₄/HNO₃/3B2/H₂O | (° C.) | Time (s) | EC | etched | ΔHaze | Δb* | etched | etched | masked | masked | Strip) |
| 4-1 | 45/15/0.01/39.99 | 35 | 30 | 10.06 | 7.85 | 0.23 | −0.01 | −0.7 | 0.02 | 0.29 | 0 | 0.09 |
| 4-2 | 45/15/0.01/39.99 | 35 | 60 | 10.09 | 1.42 | 0.52 | −0.03 | −0.6 | 0.01 | 0.18 | −0.08 | −0.16 |
| 4-3 | 45/15/0.01/39.99 | 35 | 90 | 10.72 | 0 | 0.09 | −0.01 | −0.8 | −0.03 | 0.45 | −0.07 | 0.4 |
| 4-4 | 45/15/0.01/39.99 | 35 | 120 | 10.24 | 0 | −0.05 | 0.04 | −0.4 | 0.06 | −0.04 | 0.08 | 0.13 |
| 4-5 | 45/15/0.01/39.99 | 35 | 30 | 11.42 | 0 | 0.17 | 0.05 | −0.9 | −0.05 | 0.27 | −0.1 | −0.07 |
| 4-6 | 45/15/0.01/39.99 | 35 | 60 | 10.46 | 0 | 0.05 | −0.04 | −0.6 | −0.11 | −0.09 | 0.04 | −0.02 |
| 4-7 | 45/15/0.01/39.99 | 35 | 90 | 11.66 | 0 | 0.07 | 0.05 | −0.8 | 0.04 | 0.46 | −0.03 | 0.46 |
| 4-8 | 45/15/0.01/39.99 | 35 | 120 | 9.33 | 0 | 0.03 | −0.04 | −0.6 | 0 | 0.18 | 0.08 | 0.34 |
| 4-9 | 45/15/0.01/39.99 | 35 | 30 | 9.96 | 0 | 0.05 | 0 | −0.7 | −0.08 | 0.13 | −0.16 | 0.07 |
| 4-10 | 45/15/0.01/39.99 | 35 | 60 | 9.7 | 0 | −0.2 | −0.12 | −0.7 | −0.05 | 0.06 | −0.24 | 0.33 |
| 4-11 | 45/15/0.01/39.99 | 35 | 90 | 9.56 | 0 | 0 | −0.04 | −0.5 | −0.03 | 0.16 | −0.13 | 0.11 |
| 4-12 | 45/15/0.01/39.99 | 35 | 120 | 11.52 | 0 | 0.06 | 0.09 | −0.6 | −0.07 | 0.38 | 0.03 | 0.3 |
| 4-13 | 45/15/0.01/39.99 | 35 | 30 | 8.97 | 0 | 0.15 | −0.16 | −0.7 | −0.09 | 0.43 | −0.32 | 0.25 |
| 4-14 | 45/15/0.01/39.99 | 35 | 60 | 8.99 | 0 | 0.21 | −0.11 | −0.7 | −0.11 | 0.26 | −0.25 | 0.18 |
| 4-15 | 45/15/0.01/39.99 | 35 | 90 | 10.27 | 0 | 0.15 | −0.04 | −0.7 | −0.08 | 0.21 | −0.07 | 0.23 |
| 4-16 | 45/15/0.01/39.99 | 35 | 120 | 10.15 | 0 | 0.19 | −0.11 | −0.6 | −0.05 | 0.52 | −0.31 | 0.45 |
| 4-17 | 45/15/0.01/39.99 | 35 | 30 | 9.96 | 1.99 | −0.04 | −0.14 | −0.8 | 0.02 | −0.07 | −0.1 | 0.07 |
| 4-18 | 45/15/0.01/39.99 | 35 | 60 | 9.56 | 0 | 0.07 | −0.15 | −0.8 | 0.07 | −0.03 | −0.29 | 0.06 |
| 4-19 | 45/15/0.01/39.99 | 35 | 90 | 10.95 | 0 | 0 | −0.12 | −0.9 | 0.04 | −0.01 | −0.14 | 0.12 |
| 4-20 | 45/15/0.01/39.99 | 35 | 120 | 9.34 | 0 | −0.04 | −0.23 | −0.8 | 0.08 | −0.13 | −0.36 | 0.11 |
| 4-21 | 45/15/0.01/39.99 | 35 | 30 | 9.63 | 4.33 | −0.13 | −0.17 | −0.8 | 0.03 | −0.21 | 0.18 | 0.04 |
| 4-22 | 45/15/0.01/39.99 | 35 | 60 | 9.59 | 1.3 | 0.04 | −0.09 | −0.8 | 0.05 | 0 | 0.22 | 0.14 |
| 4-23 | 45/15/0.01/39.99 | 35 | 90 | 9.76 | 0 | −0.03 | 0.04 | −0.7 | 0.03 | −0.22 | 0.31 | 0.02 |
| 4-24 | 45/15/0.01/39.99 | 35 | 120 | 10.13 | 0 | 0.05 | −0.17 | −0.8 | 0.01 | −0.33 | 0.07 | −0.01 |
| 4-25 | 45/15/0.01/39.99 | 35 | 30 | 8.41 | 8.04 | 0.22 | −0.17 | −0.7 | −0.06 | 0.25 | 0.01 | 0.19 |
| 4-26 | 45/15/0.01/39.99 | 35 | 60 | 7.55 | 5.91 | 0.19 | −0.11 | −0.7 | −0.12 | 0.37 | 0 | 0.23 |
| 4-27 | 45/15/0.01/39.99 | 35 | 90 | 7.87 | 6.77 | 0.31 | −0.12 | −0.6 | −0.13 | 0.49 | −0.04 | 0.28 |
| 4-28 | 45/15/0.01/39.99 | 35 | 120 | 7.85 | 0.2 | 0.16 | −0.1 | −0.7 | −0.17 | 0.23 | −0.07 | 0.1 |
| 4-29 | 45/15/0.01/39.99 | 40 | 30 | 10.73 | 3.59 | 0.51 | −0.01 | −0.8 | 0.07 | 0.41 | 0.01 | 0.27 |
| 4-30 | 45/15/0.01/39.99 | 40 | 60 | 12.13 | 0 | 0.28 | 0.05 | −1 | −0.05 | 0.86 | 0.13 | 0.78 |
| 4-31 | 45/15/0.01/39.99 | 40 | 90 | 10.69 | 0 | 0.18 | 0.04 | −0.8 | 0 | 0.35 | 0.01 | 0.24 |
| 4-32 | 45/15/0.01/39.99 | 40 | 120 | 11.46 | 0 | −0.05 | 0.09 | −1 | 0.11 | 0.23 | −0.03 | 0.3 |
| 4-33 | 45/15/0.01/39.99 | 40 | 30 | 9.13 | 0 | 0.22 | 0.01 | −0.9 | 0.02 | 0.08 | −0.16 | 0.13 |
| 4-34 | 45/15/0.01/39.99 | 40 | 60 | 9.71 | 0 | 0.27 | 0.02 | −0.9 | −0.02 | −0.07 | −0.17 | −0.05 |
| 4-35 | 45/15/0.01/39.99 | 40 | 90 | 9.71 | 0 | 0.15 | −0.05 | −1 | 0.01 | −0.01 | −0.17 | −0.07 |
| 4-36 | 45/15/0.01/39.99 | 40 | 120 | 9.29 | 0 | 0.23 | −0.03 | −0.9 | −0.02 | −0.12 | −0.27 | −0.13 |
| 4-37 | 45/15/0.01/39.99 | 40 | 30 | 9.82 | 0 | 0.05 | −0.02 | −0.7 | −0.08 | 0.09 | −0.19 | 0.11 |
| 4-38 | 45/15/0.01/39.99 | 40 | 60 | 12.45 | 0 | 0.06 | 0.15 | −0.7 | −0.11 | 0.32 | 0.04 | 0.25 |
| 4-39 | 45/15/0.01/39.99 | 40 | 90 | 9.61 | 0 | 0.15 | −0.06 | −0.6 | −0.05 | 0.21 | −0.17 | 0.27 |
| 4-40 | 45/15/0.01/39.99 | 40 | 120 | 11.67 | 0 | −0.09 | 0.1 | −0.6 | −0.11 | 0.27 | 0.02 | 0.37 |
| 4-41 | 45/15/0.01/39.99 | 40 | 30 | 10.3 | 0 | 0 | −0.1 | −0.7 | −0.06 | 0.33 | −0.21 | 0.35 |
| 4-42 | 45/15/0.01/39.99 | 40 | 60 | 9.89 | 0 | 0.11 | −0.11 | −0.8 | −0.08 | 0.11 | −0.36 | 0.08 |
| 4-43 | 45/15/0.01/39.99 | 40 | 90 | 10.42 | 0 | 0.07 | −0.07 | −0.7 | −0.1 | 0.15 | −0.15 | 0.15 |
| 4-44 | 45/15/0.01/39.99 | 40 | 120 | 10.05 | 0 | 0.18 | −0.15 | −0.7 | −0.05 | 0.24 | −0.37 | 0.24 |
| 4-45 | 45/15/0.01/39.99 | 40 | 30 | 8.79 | 0 | 0.1 | −0.2 | −0.9 | 0.01 | 0.15 | −0.3 | 0.18 |
| 4-46 | 45/15/0.01/39.99 | 40 | 60 | 11.01 | 0 | −0.15 | −0.13 | −0.6 | 0.13 | −0.09 | −0.29 | 0.32 |
| 4-47 | 45/15/0.01/39.99 | 40 | 90 | 8.16 | 0 | −0.07 | −0.1 | −1 | 0.05 | −0.03 | −0.22 | 0.19 |
| 4-48 | 45/15/0.01/39.99 | 40 | 120 | 10.73 | 1.9 | 0.05 | −0.29 | −0.8 | −0.01 | 0.07 | −0.65 | 0.13 |
| 4-49 | 45/15/0.01/39.99 | 40 | 30 | 10.55 | 0 | 0.02 | −0.09 | −0.7 | 0.07 | 0 | 0.05 | 0.17 |
| 4-50 | 45/15/0.01/39.99 | 40 | 60 | 8.56 | 0 | −0.07 | −0.04 | −0.7 | 0.02 | −0.11 | 0.19 | 0.07 |
| 4-51 | 45/15/0.01/39.99 | 40 | 90 | 10.19 | 0 | −0.13 | −0.09 | −0.6 | 0.05 | −0.09 | 0.28 | 0.18 |
| 4-52 | 45/15/0.01/39.99 | 40 | 120 | 9.84 | 0 | −0.01 | −0.05 | −0.7 | 0.01 | −0.08 | −0.21 | 0.19 |
| 4-53 | 45/15/0.01/39.99 | 40 | 30 | 8.74 | 6.61 | 0.16 | −0.08 | −0.7 | −0.13 | 0.39 | 0.06 | 0.33 |
| 4-54 | 45/15/0.01/39.99 | 40 | 60 | 8.56 | 0 | 0.24 | −0.06 | −0.7 | −0.1 | 0.18 | −0.07 | 0.11 |
| 4-55 | 45/15/0.01/39.99 | 40 | 90 | 8.96 | 0.08 | 0.41 | −0.12 | −0.8 | −0.01 | 0.37 | −0.12 | 0.4 |
| 4-56 | 45/15/0.01/39.99 | 40 | 120 | 8.87 | 0 | −0.2 | −0.09 | −1.2 | −0.11 | −0.06 | −0.07 | 0.26 |

### Example 5

Samples of FLEXX™ 100 transparent conductive film (Samples 5-1 to 5-5 and 5-16 to 5-20 from Lot 350-3102; Samples 5-6 to 5-10 and 5-21 to 5-25 from Lot 403-3104; Samples 5-11 to 5-15 and 5-26 to 5-30 from Lot 403-3105; Carestream Health, Inc., Rochester, N.Y.), which had a resistivity of 100 Ohms, were annealed at 150° C. for 30 minutes. Initial measurements of electrical conductivity, percent transmittance, percent haze, and CIE L*, a*, and b* color metrics were recorded. Rectangular peelable masks were disposed onto the samples by screen printing a substance known as HOYO M1-B077 and cured for 20 minutes at 130° C. The masked samples were dipped into a selected etchant composition (varying wt % of H₃PO₄, HNO₃, DOWFAX™ 3B2 surfactant) at 30° C. for selected times (30, 60, 90, 120, or 150 seconds). To remove excess etchant, the samples were washed with distilled water and dried with compressed air using a blower. The masks were removed by being peeled from the samples. The samples were washed with distilled water and air dried. Final measurements of conductivity, percent transmittance, percent haze, and CIE L*, a*, and b* color metrics were recorded for the etched and masked areas. Table 5 shows the percent change in electrical conductivity, change in percent haze, and change in b* of the etched regions after the mask were removed and of the masked regions after etching.

TABLE 5

| | Etchant | | | | | | | |
|---|---|---|---|---|---|---|---|---|
| | Composition | Etching | % EC | % EC | | | | |
| | (wt %) | Time | Change | Change | ΔH | ΔH | Δb* | Δb* |
| Sample | HPO₄/HNO₃/3B2 | (s) | (etch) | (mask) | (etch) | (mask) | (etch) | (mask) |
| 5-1 | 42.5/15/0.01 | 30 | −1.99 | −5.40 | 0 | −0.42 | −0.23 | −0.16 |
| 5-2 | 42.5/15/0.01 | 60 | 15.44 | −1.79 | 0 | −0.25 | −0.01 | −0.08 |
| 5-3 | 42.5/15/0.01 | 90 | 30.65 | −2.85 | 0.01 | −0.32 | 0 | 0.09 |
| 5-4 | 42.5/15/0.01 | 120 | 100.00 | −0.90 | −0.07 | −0.36 | 0.29 | 0.12 |
| 5-5 | 42.5/15/0.01 | 150 | 100.00 | 0.64 | −0.15 | −0.24 | 0.36 | −0.21 |
| 5-6 | 42.5/15/0.01 | 30 | 1.17 | −5.39 | 0 | 0.07 | 0.01 | 0.31 |
| 5-7 | 42.5/15/0.01 | 60 | 13.18 | −2.09 | −0.02 | 0.01 | 0.05 | −0.03 |
| 5-8 | 42.5/15/0.01 | 90 | 30.65 | −5.20 | −0.02 | 0.04 | 0.16 | 0.16 |
| 5-9 | 42.5/15/0.01 | 120 | 74.43 | 0.17 | −0.01 | 0.12 | 0.19 | 0.1 |
| 5-10 | 42.5/15/0.01 | 150 | 100.00 | −0.68 | −0.11 | −0.03 | 0.32 | 0.18 |
| 5-11 | 42.5/15/0.01 | 30 | 3.72 | −6.88 | −0.01 | 0.14 | 0.05 | 0.1 |
| 5-12 | 42.5/15/0.01 | 60 | 28.26 | −5.95 | −0.03 | 0.17 | 0.02 | −0.11 |
| 5-13 | 42.5/15/0.01 | 90 | 29.33 | −2.49 | −0.04 | 0.25 | 0.05 | 0.09 |
| 5-14 | 42.5/15/0.01 | 120 | 56.93 | 0.78 | −0.02 | 0.36 | 0.06 | 0.02 |
| 5-15 | 42.5/15/0.01 | 150 | 99.43 | 0.25 | −0.09 | 0.23 | 0.27 | 0.07 |
| 5-16 | 45/15/0.01 | 30 | 2.10 | −4.00 | −0.02 | −0.44 | −0.13 | −0.15 |
| 5-17 | 45/15/0.01 | 60 | 38.55 | −0.09 | 0 | −0.33 | 0.02 | 0.12 |
| 5-18 | 45/15/0.01 | 90 | 99.39 | 1.13 | −0.04 | −0.24 | 0.18 | −0.34 |
| 5-19 | 45/15/0.01 | 120 | 100.00 | −0.09 | −0.21 | −0.32 | 0.32 | 0.12 |
| 5-20 | 45/15/0.01 | 150 | 100.00 | 0.45 | −0.24 | −0.47 | 0.39 | −0.63 |
| 5-21 | 45/15/0.01 | 30 | 21.57 | −1.93 | −0.01 | −0.02 | 0.04 | 0 |
| 5-22 | 45/15/0.01 | 60 | 89.32 | −3.85 | −0.07 | 0.01 | 0.3 | 0.07 |
| 5-23 | 45/15/0.01 | 90 | 100.00 | −0.44 | −0.11 | −0.04 | 0.3 | 0.03 |
| 5-24 | 45/15/0.01 | 120 | 100.00 | −2.04 | −0.39 | 0.13 | 0.27 | 0.09 |
| 5-25 | 45/15/0.01 | 150 | 100.00 | 3.13 | −0.57 | 0.04 | 0.03 | 0.08 |
| 5-26 | 45/15/0.01 | 30 | 23.71 | −6.55 | −0.05 | 0.1 | 0.05 | 0.05 |
| 5-27 | 45/15/0.01 | 60 | 100.00 | −3.02 | −0.26 | 0.12 | 0.09 | −0.28 |
| 5-28 | 45/15/0.01 | 90 | 100.00 | −3.28 | −0.46 | 0.21 | 0.02 | −0.14 |
| 5-29 | 45/15/0.01 | 120 | 100.00 | 0.98 | −0.72 | 0.26 | −0.48 | −0.34 |
| 5-30 | 45/15/0.01 | 150 | 100.00 | 2.16 | −0.69 | 0.22 | −0.21 | 0.07 |

### Example 6

Samples of FLEXX™ 100 transparent conductive film (Samples 6-1 to 6-5 and 6-16 to 6-20 from Lot 350-3102; Samples 6-6 to 6-10 and 6-21 to 6-25 from Lot 403-3104; Samples 6-11 to 6-15 and 6-26 to 6-30 from Lot 403-3105; Carestream Health, Inc., Rochester, N.Y.), which had a resistivity of 100 Ohms, were annealed at 150° C. for 30 minutes. Initial measurements of electrical conductivity, percent transmittance, percent haze, and CIE L*, a*, and b* color metrics were recorded. Rectangular peelable masks were disposed onto the samples by screen printing a substance known as HOYO M1-B077 and cured for 20 minutes at 130° C. The masked samples were dipped into a selected etchant composition (varying wt % of H₃PO₄, HNO₃, DOWFAX™ 3B2 surfactant) at selected temperatures (30° C. or 35° C.) for selected times (30, 60, 90, 120, or 150 seconds). Samples 6-1 to 6-15 were etched at 30° C. Samples 6-1 to 6-15 were etched at 35° C. To remove excess etchant, the samples were washed with distilled water and dried with compressed air using a blower. The masks were removed by being peeled from the samples. The samples were washed with distilled water and air dried. Final measurements of conductivity, percent transmittance, percent haze, and CIE L*, a*, and b* color metrics were recorded for the etched and masked areas. Table 6 shows the percent change in electrical conductivity, change in percent haze, and change in b* of the etched regions after the mask were removed and of the masked regions after etching.

TABLE 6

| | Etchant | | | | | | | |
|---|---|---|---|---|---|---|---|---|
| | Composition | Etching | % EC | % EC | | | | |
| | (wt %) | Time | Change | Change | ΔH | ΔH | Δb* | Δb* |
| Sample | HPO4/HNO3/3B2 | (s) | (etched) | (masked) | (etched) | (masked) | (etched) | (masked) |
| 6-1 | 45/13.75/0.01 | 30 | 1.80 | −1.73 | 0 | −0.25 | −0.02 | −0.44 |
| 6-2 | 45/13.75/0.01 | 60 | 29.21 | −0.09 | −0.01 | −0.16 | 0.08 | −0.48 |
| 6-3 | 45/13.75/0.01 | 90 | 49.21 | −1.02 | 0 | −0.21 | 0.14 | −0.25 |
| 6-4 | 45/13.75/0.01 | 120 | 81.29 | −0.08 | −0.03 | −0.3 | 0.21 | −0.54 |
| 6-5 | 45/13.75/0.01 | 150 | 96.89 | −1.65 | 0.03 | −0.38 | 0.61 | 0.05 |
| 6-6 | 45/13.75/0.01 | 30 | 1.53 | −4.50 | 0.04 | 0.02 | −0.51 | 0.03 |
| 6-7 | 45/13.75/0.01 | 60 | 41.63 | −4.32 | 0.01 | 0.08 | −0.68 | −0.24 |
| 6-8 | 45/13.75/0.01 | 90 | 91.20 | −0.26 | −0.04 | −0.02 | −0.8 | −0.22 |
| 6-9 | 45/13.75/0.01 | 120 | 100.00 | −2.09 | −0.09 | 0.28 | −0.53 | −0.44 |
| 6-10 | 45/13.75/0.01 | 150 | 100.00 | −1.21 | −0.08 | 0.12 | −0.63 | −0.9 |
| 6-11 | 45/13.75/0.01 | 30 | 24.93 | −2.74 | 0.02 | 0.29 | −0.62 | −0.6 |
| 6-12 | 45/13.75/0.01 | 60 | 100.00 | −0.82 | −0.13 | 0.3 | −0.63 | −0.77 |
| 6-13 | 45/13.75/0.01 | 90 | 100.00 | −8.02 | −0.17 | 0.34 | −0.32 | −0.34 |
| 6-14 | 45/13.75/0.01 | 120 | 100.00 | −4.22 | −0.23 | 0.39 | −0.24 | −0.29 |
| 6-15 | 45/13.75/0.01 | 150 | 100.00 | 0.62 | −0.44 | 0.46 | −0.03 | 0.17 |
| 6-16 | 45/13.75/0.01 | 30 | 13.00 | −2.31 | 0.03 | −0.41 | −0.23 | 0.33 |
| 6-17 | 45/13.75/0.01 | 60 | 55.30 | −0.85 | 0 | −0.26 | −0.25 | 0.17 |
| 6-18 | 45/13.75/0.01 | 90 | 100.00 | −0.56 | −0.07 | −0.18 | −0.07 | 0.37 |
| 6-19 | 45/13.75/0.01 | 120 | 100.00 | −0.42 | −0.28 | 0.03 | 0.2 | −0.04 |
| 6-20 | 45/13.75/0.01 | 150 | 100.00 | 0.33 | −0.36 | 0.22 | −0.09 | −0.59 |
| 6-21 | 45/13.75/0.01 | 30 | 11.71 | −4.41 | 0.09 | 0.27 | 0.6 | −0.42 |
| 6-22 | 45/13.75/0.01 | 60 | 84.14 | 0.72 | 0.06 | 0.17 | 0.6 | −0.29 |
| 6-23 | 45/13.75/0.01 | 90 | 100.00 | 4.82 | −0.12 | 0.28 | 0.77 | −0.45 |
| 6-24 | 45/13.75/0.01 | 120 | 100.00 | −0.17 | −0.15 | 0.33 | −0.27 | −0.27 |
| 6-25 | 45/13.75/0.01 | 150 | 100.00 | −0.79 | −0.53 | 0.31 | −0.01 | −0.27 |
| 6-26 | 45/13.75/0.01 | 30 | 76.57 | −3.00 | −0.03 | 0.13 | −0.13 | −0.25 |
| 6-27 | 45/13.75/0.01 | 60 | 100.00 | −1.15 | 0.01 | 0.2 | −0.35 | −0.25 |
| 6-28 | 45/13.75/0.01 | 90 | 100.00 | 3.94 | −0.12 | 0.12 | −0.26 | −0.28 |
| 6-29 | 45/13.75/0.01 | 120 | 100.00 | −0.28 | −0.52 | 0.15 | 0.11 | 0.14 |
| 6-30 | 45/13.75/0.01 | 150 | 100.00 | −0.56 | −0.76 | 0.6 | −0.13 | 0.28 |

### Example 7

Samples of FLEXX™ 100 transparent conductive film (Samples 7-1 to 7-5 and 7-16 to 7-20 from Lot 350-3102; Samples 7-6 to 7-10 and 7-21 to 7-25 from Lot 403-3104; Samples 7-11 to 7-15 and 7-26 to 7-30 from Lot 403-3105; Carestream Health, Inc., Rochester, N.Y.), which had a resistivity of 100 Ohms, were annealed at 150° C. for 30 minutes. Initial measurements of electrical conductivity, percent transmittance, percent haze, and CIE L*, a*, and b* color metrics were recorded. Rectangular peelable masks were disposed onto the samples by screen printing a substance known as HOYO M1-B077 and cured for 20 minutes at 130° C. The masked samples were dipped into a selected etchant composition (varying wt % of H₃PO₄, HNO₃, DOWFAX™ 3B2 surfactant) at 35° C. for selected times (30, 60, 90, 120, or 150 seconds). To remove excess etchant, the samples were washed with distilled water and dried with compressed air using a blower. The masks were removed by being peeled from the samples. The samples were washed with distilled water and air dried. Final measurements of conductivity, percent transmittance, percent haze, and CIE L*, a*, and b* color metrics were recorded for the etched and masked areas. Table 7 shows the percent change in electrical conductivity, change in percent haze, and change in b* of the etched regions after the mask was removed and of the masked regions after etching.

TABLE 7

| | Etchant | | | | | | | |
|---|---|---|---|---|---|---|---|---|
| | Composition | Etching | % EC | % EC | | | | |
| | (wt %) | Time | Change | Change | ΔH | ΔH | Δb* | Δb* |
| Sample | HPO₄/HNO₃/3B2 | (s) | (etched) | (masked) | (etched) | (masked) | (etched) | (masked) |
| 7-1 | 45/12.5/0.01 | 30 | 4.29 | 1.08 | 0 | −0.32 | 0.16 | 0.18 |
| 7-2 | 45/12.5/0.01 | 60 | 11.11 | −0.78 | 0.02 | −0.21 | −0.05 | −0.08 |
| 7-3 | 45/12.5/0.01 | 90 | 31.71 | 1.26 | −0.05 | −0.38 | 0.08 | −0.18 |
| 7-4 | 45/12.5/0.01 | 120 | 62.97 | 0.76 | −0.06 | −0.41 | −0.28 | −0.43 |
| 7-5 | 45/12.5/0.01 | 150 | 100.00 | −0.75 | −0.05 | −0.17 | 0.16 | −0.42 |
| 7-6 | 45/12.5/0.01 | 30 | 2.32 | −6.16 | 0 | −0.04 | 0.07 | 0.03 |
| 7-7 | 45/12.5/0.01 | 60 | 11.89 | −1.93 | −0.01 | 0.03 | 0.02 | −0.04 |
| 7-8 | 45/12.5/0.01 | 90 | 40.35 | 0.81 | 0 | 0.01 | 0 | 0.02 |
| 7-9 | 45/12.5/0.01 | 120 | 71.89 | −1.46 | 0.08 | 0 | 0.15 | 0.07 |
| 7-10 | 45/12.5/0.01 | 150 | 100.00 | −4.55 | −0.26 | 0.07 | 0.26 | 0.02 |
| 7-11 | 45/12.5/0.01 | 30 | 29.11 | −8.17 | 0.01 | 0 | −0.08 | −0.13 |
| 7-12 | 45/12.5/0.01 | 60 | 84.16 | −5.77 | 0.08 | 0.12 | 0.13 | −0.01 |
| 7-13 | 45/12.5/0.01 | 90 | 100.00 | −5.48 | −0.14 | 0.15 | 0.2 | −0.18 |
| 7-14 | 45/12.5/0.01 | 120 | 100.00 | −4.42 | −0.3 | 0.4 | −0.06 | −0.26 |
| 7-15 | 45/12.5/0.01 | 150 | 100.00 | −2.09 | −0.34 | 0.45 | −0.39 | −0.69 |
| 7-16 | 42.5/13.75/0.01 | 30 | 2.25 | −3.80 | 0.04 | −0.25 | −0.21 | −0.31 |
| 7-17 | 42.5/13.75/0.01 | 60 | 11.69 | 0.09 | −0.03 | −0.29 | −0.06 | 0.02 |
| 7-18 | 42.5/13.75/0.01 | 90 | 53.51 | −1.41 | −0.03 | −0.29 | −0.1 | −0.28 |
| 7-19 | 42.5/13.75/0.01 | 120 | 94.13 | 0.75 | −0.07 | −0.3 | 0.08 | −0.24 |
| 7-20 | 42.5/13.75/0.01 | 150 | 100.00 | 0.00 | −0.08 | −0.38 | 0.29 | −0.61 |
| 7-21 | 42.5/13.75/0.01 | 30 | 4.79 | −5.57 | 0.08 | −0.08 | 0 | −0.01 |
| 7-22 | 42.5/13.75/0.01 | 60 | 35.29 | −2.11 | 0.02 | 0 | 0.05 | 0.08 |
| 7-23 | 42.5/13.75/0.01 | 90 | 73.19 | −0.70 | −0.03 | −0.1 | 0.14 | 0.02 |
| 7-24 | 42.5/13.75/0.01 | 120 | 80.80 | 0.00 | −0.03 | −0.09 | 0.37 | −0.04 |
| 7-25 | 42.5/13.75/0.01 | 150 | 100.00 | 0.61 | −0.17 | 0.11 | 0.04 | −0.42 |
| 7-26 | 42.5/13.75/0.01 | 30 | 21.09 | −1.95 | 0.04 | 0.13 | −0.07 | 0.01 |
| 7-27 | 42.5/13.75/0.01 | 60 | 79.75 | −4.79 | −0.03 | 0.09 | 0.12 | −0.18 |
| 7-28 | 42.5/13.75/0.01 | 90 | 90.98 | −1.96 | −0.06 | 0.1 | 0.08 | −0.07 |
| 7-29 | 42.5/13.75/0.01 | 120 | 100.00 | −3.78 | −0.01 | 0.17 | 0.11 | −0.33 |
| 7-30 | 42.5/13.75/0.01 | 150 | 100.00 | −6.49 | −0.36 | 0.12 | 0.15 | 0.03 |

### Example 8

Samples of FLEXX™ 100 transparent conductive film (Samples 8-1 to 8-6 from Lot 416-3104; Samples 8-7 to 8-12 from Lot 416-3117; Samples 8-13 to 8-17 from Lot 416-3128; Carestream Health, Inc., Rochester, N.Y.), which had a resistivity of 100 Ohms, were annealed at 150° C. for 30 minutes. Initial measurements of electrical conductivity, percent transmittance, percent haze, and CIE L*, a*, and b* color metrics were recorded. Rectangular peelable masks were disposed onto the samples by screen printing a substance known as HOYO M1-B077 and cured for 20 minutes at 130° C. The masked samples were dipped into a selected etchant composition (varying wt % of H₃PO₄, HNO₃, DOWFAX™ 3B2 surfactant) at 30° C. for selected times (120, 240, 270, 300, 330, 360, 390, 420, 450, 480, 510, 540 seconds, etc.). To remove excess etchant, the samples were washed with distilled water and dried with compressed air using a blower. The masks were removed by being peeled from the samples. The samples were washed with distilled water and air dried. Final measurements of conductivity, percent transmittance, percent haze, and CIE L*, a*, and b* color metrics were recorded for the etched and masked areas. Table 8 shows the percent change in electrical conductivity, change in haze, and change in b* of the etched regions after the mask were removed and of the masked regions after etching.

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the attached claims, and all changes that come within the meaning and range of equivalents thereof are intended to be embraced therein.

TABLE 8

| | Etchant | | | | | | | |
|---|---|---|---|---|---|---|---|---|
| | Composition | Etching | % EC | % EC | | | | |
| | (wt %) | Time | Change | Change | ΔH | ΔH | Δb* | Δb* |
| Sample | HPO₄/HNO₃/3B2 | (s) | (etched) | (masked) | (etched) | (masked) | (etched) | (masked) |
| 8-1 | 42.5/15/0.01 | 120 | 10.74 | −3.05 | −0.06 | −0.07 | −0.18 | −0.14 |
| 8-2 | 42.5/15/0.01 | 300 | 26.37 | −5.76 | 0.02 | 0.12 | −0.04 | −0.26 |
| 8-3 | 42.5/15/0.01 | 420 | 78.03 | −1.21 | −0.1 | 0.09 | −0.03 | −0.14 |
| 8-4 | 42.5/15/0.01 | 480 | 86.90 | −2.53 | −0.03 | 0.2 | 0 | −0.51 |
| 8-5 | 42.5/15/0.01 | 540 | 100.00 | −0.24 | −0.28 | 0.18 | −0.19 | −0.17 |
| 8-6 | 42.5/15/0.01 | 510 | 100.00 | −1.76 | −0.06 | 0.26 | 0.06 | −0.21 |
| 8-7 | 42.5/15/0.01 | 120 | 10.98 | −6.56 | 0.04 | −0.1 | −0.23 | −0.35 |
| 8-8 | 42.5/15/0.01 | 300 | 61.59 | −4.32 | −0.09 | −0.02 | −0.06 | −0.08 |
| 8-9 | 42.5/15/0.01 | 420 | 100.00 | −6.31 | 0.23 | 0.06 | −0.07 | −0.57 |
| 8-10 | 42.5/15/0.01 | 390 | 77.57 | −1.65 | −0.03 | 0.04 | 0.13 | −0.12 |
| 8-11 | 42.5/15/0.01 | 450 | 100.00 | −6.11 | −0.12 | 0.02 | 0.01 | −0.5 |
| 8-12 | 42.5/15/0.01 | 480 | 100.00 | −3.02 | −0.24 | 0 | −0.25 | −0.09 |
| 8-13 | 42.5/15/0.01 | 240 | 31.21 | −1.88 | 0.05 | 0.17 | −0.11 | −0.45 |
| 8-14 | 42.5/15/0.01 | 300 | 100.00 | −0.57 | −0.12 | 0.08 | −0.01 | −0.28 |
| 8-15 | 42.5/15/0.01 | 270 | 55.86 | 0.38 | −0.04 | 0.11 | 0.02 | −0.33 |
| 8-16 | 42.5/15/0.01 | 330 | 100.00 | −1.61 | −0.22 | 0.23 | −0.13 | −0.42 |
| 8-17 | 42.5/15/0.01 | 360 | 98.66 | 0.00 | 0.14 | 0.22 | 0.25 | −0.35 |

What is claimed:

1. A method comprising:
etching a film comprising electrically conductive structures according to a pattern using an aqueous etching solution to provide an etched region having a first conductivity and an unetched region having a second conductivity, the second conductivity being greater than the first conductivity,
wherein the aqueous etching solution comprises 25 to 65% by weight of phosphoric acid and 1 to 18% by weight of nitric acid.

2. The method according to claim 1, wherein the aqueous solution comprises at least one surfactant.

3. The method according to claim 2, wherein the at least one surfactant comprises at least one anionic surfactant.

4. The method according to claim 2, wherein the at least one surfactant comprises decyl(sulfophenoxy)benzenesulfonic acid, disodium salt and oxybis(decylbenzenesulfonic acid), disodium salt.

5. The method according to claim 2, wherein the aqueous etching solution comprises 40 to 60% by weight of phosphoric acid, 10 to 15% by weight of nitric acid, and 0.005-0.05% by weight of the at least one surfactant.

6. The method according to claim 1,
wherein prior to etching, the film exhibited a preexisting set of optical properties, and wherein after etching, the etched region exhibited a first consequent set of optical properties, and the unetched region exhibited a second consequent set of optical properties, and
further wherein the preexisting set of optical properties and the first consequent set of optical properties are substantially identical.

7. The method according to claim 6, wherein the preexisting set of optical properties comprises a preexisting total light transmission and the first consequent set of optical properties comprises a first consequent total light transmission that is substantially identical to the preexisting total light transmission.

8. The method according to claim 6, wherein the preexisting set of optical properties comprises a preexisting haze and the first consequent set of optical properties comprises a first consequent haze that is substantially identical to the preexisting haze.

9. The method according to claim 6, wherein the preexisting set of optical properties comprises a preexisting L* value and the first consequent set of optical properties comprises a first consequent L* value that is substantially identical to the preexisting L* value.

10. The method according to claim 6, wherein the preexisting set of optical properties comprises a preexisting a* value and the first consequent set of optical properties comprises a first consequent a* value that is substantially identical to the preexisting a* value.

11. The method according to claim 6, wherein the preexisting set of optical properties comprises a preexisting b* value and the first consequent set of optical properties comprises a first consequent b* value that is substantially identical to the preexisting b* value.

12. The method according to claim 6, wherein the first consequent set of optical properties and the second consequent set of optical properties are substantially identical.

13. The method according to claim 6, wherein after etching, the pattern is invisible to the unaided eye.

14. The method according to claim 6, wherein the electrically conductive structures comprise silver nanowires.

15. A method comprising:
etching a film comprising electrically conductive structures according to a pattern using an aqueous etching solution to provide an etched region having a first conductivity and an unetched region having a second conductivity, the second conductivity being greater than the first conductivity,
wherein the aqueous etching solution comprises 65 to 75% by weight of nitric acid.
